(19) United States
(12) Patent Application Publication
(10) Pub. No.: US 2015/0378498 A1
(43) Pub. Date: Dec. 31, 2015

(54) HYBRID CAPACITIVE SENSOR DEVICE

(71) Applicant: Synaptics Incorporated, San Jose, CA (US)

(72) Inventor: Mark HUIE, Sunnyvale, CA (US)

(73) Assignee: SYNAPTICS INCORPORATED, San Jose, CA (US)

(21) Appl. No.: 14/320,125

(22) Filed: Jun. 30, 2014

(51) Int. Cl. G06F 3/041; G06F 1/16; G06F 3/044

(52) U.S. Cl. CPC G06F 3/0416; G06F 3/044; G06F 1/169; G06F 2203/04101

(57) ABSTRACT

In an example, an input device includes: a plurality of transmitter electrodes including: a first transmitter electrode having a first set of sub-electrodes; and a second transmitter electrode having a second set of sub-electrodes, where the number of sub-electrodes in the first set is different than the number of sub-electrodes in the second set; a plurality of receiver electrodes; and a processing system, coupled to the plurality of transmitter electrodes and the plurality of receiver electrodes, the processing system configured to: drive, in a first mode, the plurality of transmitter electrodes with transmitter signals while receiving resulting signals from the plurality of receiver electrodes to determine changes in transcapacitance; and drive, in a second mode, the plurality of transmitter electrodes with absolute capacitive sensing signals to determine changes in absolute capacitance.

### BACKGROUND

1. Field of the Disclosure

Embodiments generally relate to input sensing and, in particular, to input sensing using a hybrid capacitive sensor device.

2. Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location, and/or motion of one or more input objects. Input objects can be at or near the surface of the proximity sensor device (“touch sensing”) or hovering over the surface of the proximity sensor device (“proximity sensing” or “hover sensing”). Proximity sensor devices may be used to provide interfaces for the electronic system. For example, proximity sensor devices are often used as input devices for larger computing systems (such as touchpads integrated in, or peripheral to, notebook or desktop computers). Proximity sensor devices are also often used in smaller computing systems (such as touch screens integrated in cellular phones or tablet computers).

### SUMMARY

Embodiments generally provide a processing system, input device and method of driving a hybrid capacitive sensor device to detect proximate objects. In an embodiment, an input device, includes: a plurality of transmitter electrodes including: a first transmitter electrode having a first set of sub-electrodes; and a second transmitter electrode having a second set of sub-electrodes, where the number of sub-electrodes in the first set is different than the number of sub-electrodes in the second set; a plurality of receiver electrodes; and a processing system, coupled to the plurality of transmitter electrodes and the plurality of receiver electrodes, the processing system configured to: drive, in a first mode, the plurality of transmitter electrodes with transmitter signals while receiving resulting signals from the plurality of receiver electrodes to determine changes in transcapacitance; and drive, in a second mode, the plurality of transmitter electrodes with absolute capacitive sensing signals to determine changes in absolute capacitance

In an embodiment, a method of driving transmitter electrodes and receiver electrodes for capacitive sensing includes: driving, in a first mode, a the transmitter electrodes with transmitter signals while receiving resulting signals from the receiver electrodes to determine changes in transcapacitance, the transmitter electrodes including: a first transmitter electrode having a first set of sub-electrodes; and a second transmitter electrode having a second set of sub-electrodes, where the number of sub-electrodes in the first set is different than the number of sub-electrodes in the second set; and driving, in a second mode, the transmitter electrodes with absolute capacitive sensing signals to determine changes in absolute capacitance.

In an embodiment, a processing system includes: a sensor module comprising sensor circuitry, the sensor module configured to: drive, in a first mode, a plurality of transmitter electrodes with transmitter signals while receiving resulting signals from a plurality of receiver electrodes to determine changes in transcapacitance, the plurality of transmitter electrodes including: a first transmitter electrode having a first set of sub-electrodes; and a second transmitter electrode having a second set of sub-electrodes, where the number of sub-electrodes in the first set is different than the number of sub-electrodes in the second set; and drive, in a second mode, the plurality of transmitter electrodes with capacitive sensing signals to determine changes in absolute capacitance; and a determination module configured to determine positional information for at least one input object based on changes in capacitance determined by the sensor module.

### BRIEF DESCRIPTION OF THE DRAWINGS

So that the manner in which the above recited features of embodiments can be understood in detail, a more particular description of embodiments, briefly summarized above, may be had by reference to embodiments, some of which are illustrated in the appended drawings. It is to be noted, however, that the appended drawings illustrate only typical embodiments and are therefore not to be considered limiting of scope, for other equally effective embodiments may be admitted.

FIG. 1 is a block diagram of a system that includes an input device according to an example implementation.

FIG. 2 is a block diagram depicting a capacitive sensor device for an input device according to an example implementation.

FIGS. 3A-3C show configurations of the sensor electrodes and sub-electrodes according to example implementations.

FIG. 4 is a block diagram depicting a capacitive sensor device according to an example implementation.

FIG. 5 is a flow diagram showing a method of driving sensor electrodes for capacitive sensing according to an example implementation.

FIG. 6 is a flow diagram showing another method of driving sensor electrodes for capacitive sensing according to an example implementation.

FIG. 7 is an exploded side view of a display device having an integrated input device according to an example implementation.

FIG. 8 is an exploded side view of a display device having an integrated input device according to an example implementation.

To facilitate understanding, identical reference numerals have been used, where possible, to designate identical elements that are common to the figures. It is contemplated that elements of one embodiment may be beneficially incorporated in other embodiments.

### DETAILED DESCRIPTION

The following detailed description is merely exemplary in nature and is not intended to limit the embodiments or the application and uses of such embodiments. Furthermore, there is no intention to be bound by any expressed or implied theory presented in the preceding technical field, background, brief summary or the following detailed description.

Various embodiments provide input devices and methods that provide a hybrid capacitive sensor device. In an example, an input device can include a sensor device that employs two sets of non-parallel sensor electrodes. The sensor device uses the sensor electrodes to form a sensing region in which input object(s) touching a surface of the input device, or hovering over the surface, can be detected (generally referred to as “proximity sensing”). One of the sets of sensor electrodes includes a plurality of sub-electrodes. For example, sensor electrodes in a selected set can be subdivided into a plurality of sub-electrodes.

The sensor device can operate in a first mode to perform transcapacitive sensing, where one set of sensor electrodes includes transmitter electrodes and the other set of sensor electrodes includes receiver electrodes. The set of sensor electrodes that includes the sub-electrodes are used as the transmitter electrodes, and the other set of sensor electrodes are used as the receiver electrodes. In the first mode, the sub-electrodes of each of the subdivided transmitter electrodes are driven with a transmitter signal simultaneously as a group. The sensor device can also operate in a second mode to perform absolute capacitive sensing. In the second mode, the sub-electrodes of each of the subdivided sensor electrodes are driven individually with an absolute capacitive sensing signal.

Thus, the sensor device includes a sensor electrode pattern that allows for transcapacitive sensing and capacitive imaging of input object(s) in a first mode, and absolute capacitive sensing and capacitive imaging of input object(s) in a second mode. In the first mode, the capacitive image is formed from changes in transcapacitance in sensing regions formed by the non-parallel transmitter and receiver electrodes. In the second mode, the capacitive image is formed from changes in absolute capacitance in sensing regions formed by a matrix of discrete sensor electrodes formed by the sub-electrodes. In general, the matrix of sub-electrodes can provide fewer sensing regions than those formed by the non-parallel transmitter and receiver electrodes. As such, the absolute capacitive image generated in the second mode can have a lower resolution than the transcapacitive image generated in the first mode. However, the absolute capacitive image generated in the second mode can provide for more reliable detection of hovering input object(s) than the transcapacitive image generated in the first mode. These and further aspects are described further below.

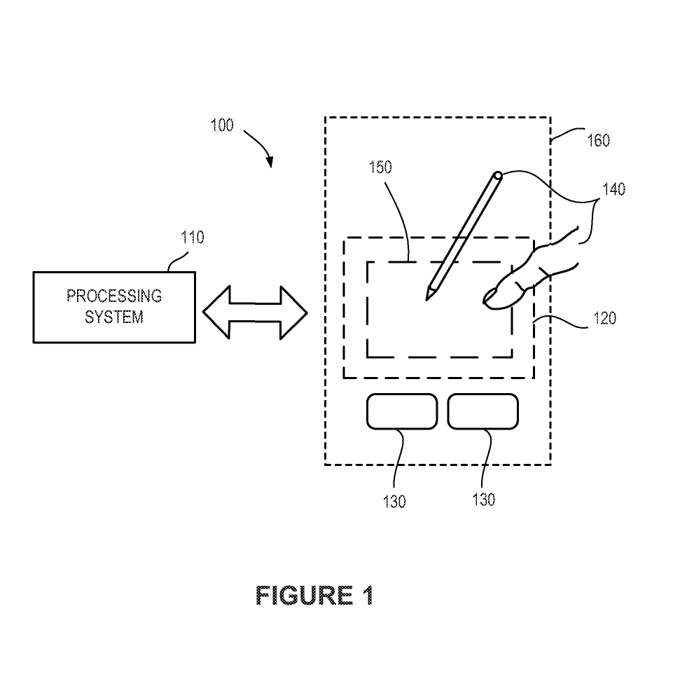

Turning now to the figures, FIG. 1 is a block diagram of an exemplary input device 100 in accordance with embodiments. In various embodiments, the input device 100 comprises a sensing device and optionally a display device 160. In an embodiment, the input device 100 comprises a display device 160 having an integrated sensing device, such as a capacitive sensing device. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice) and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system or can be physically separate from the electronic system. As appropriate, the input device 100 may communicate with parts of the electronic system using any one or more of the following: buses, networks, and other wired or wireless interconnections (including serial and or parallel connections). Examples include I²C, SPI, PS/2, Universal Serial Bus (USB), Bluetooth, RF, and IRDA.

In the embodiment depicted in FIG. 1, the input device 100 is shown as a proximity sensor device (also often referred to as a “touchpad” or a “touch sensor device”) configured to sense input provided by one or more input objects 140 in a sensing region 120. Example input objects 140 include fingers and styli, as shown in FIG. 1.

Sensing region 120 overlays the display screen of the display device 160 and encompasses any space above, around, in, and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100. The face sheet (e.g., an LCD lens) may provide a useful contact surface for an input object.

The input device 100 may utilize any combination of sensor components and sensing technologies to detect user input in the sensing region 120. The input device 100 comprises one or more sensing elements for detecting user input. Some implementations are configured to provide images that span one, two, three, or higher dimensional spaces. Some implementations are configured to provide projections of input along particular axes or planes. Cursors, menus, lists, and items may be displayed as part of a graphical user interface and may be scaled, positioned, selected scrolled, or moved.

In some capacitive implementations of the input device 100, voltage or current is applied to create an electric field. Nearby input objects cause changes in the electric field and produce detectable changes in capacitive coupling that may be detected as changes in voltage, current, or the like.

Some capacitive implementations utilize arrays or other regular or irregular patterns of capacitive sensing elements 150, such as sensor electrodes, to create electric fields. In some capacitive implementations, separate sensing elements 150 may be ohmically shorted together to form larger sensor electrodes. Some capacitive implementations utilize resistive sheets (e.g., may comprise a resistive material such as ITO or the like), which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, changing the measured capacitive coupling. In one implementation, an absolute capacitance sensing method operates by modulating sensor electrodes with respect to a reference voltage (e.g., system ground) and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals and/or to one or more sources of environmental interference (e.g., other electromagnetic signals). Sensor electrodes may be dedicated transmitters or receivers, or sensor electrodes may be configured to both transmit and receive. Alternatively, the receiver electrodes may be modulated relative to ground.

In FIG. 1, a processing system 110 is shown as part of the input device 100. The processing system 110 is configured to operate the hardware of the input device 100 to detect input in the sensing region 120. The sensing region 120 includes an array of sensing elements 150. The processing system 110 comprises parts of, or all of, one or more integrated circuits (ICs) and/or other circuitry components. For example, a processing system for a mutual capacitance sensor device may comprise transmitter circuitry configured to transmit signals with transmitter sensor electrodes and/or receiver circuitry configured to receive signals with receiver sensor electrodes. In some embodiments, the processing system 110 also comprises electronically-readable instructions, such as firmware code, software code, and/or the like. In some embodiments, components of the processing system 110 are located together, such as near sensing element(s) of the input device 100. In other embodiments, components of processing system 110 are physically separate with one or more components close to sensing element(s) of input device 100 and one or more components elsewhere. For example, the input device 100 may be a peripheral coupled to a desktop computer, and the processing system 110 may include software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120 or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 of the sensing device overlaps at least part of an active area of a display screen of the display device 160. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments are described in the context of a fully functioning apparatus, the mechanisms of the embodiments are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

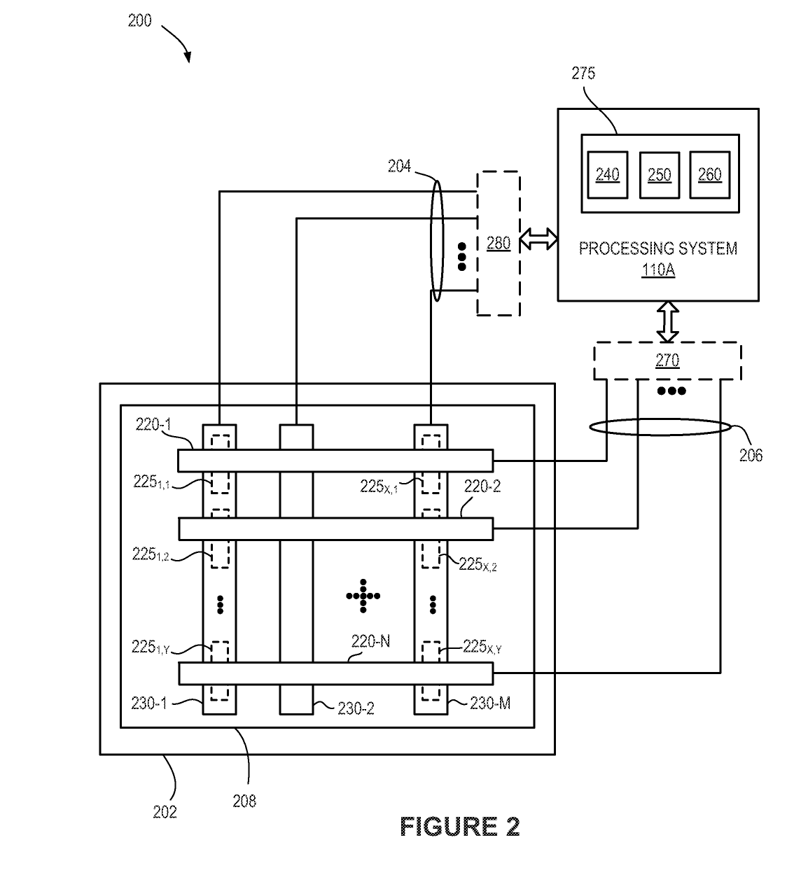

FIG. 2 is a block diagram depicting a capacitive sensor device 200 according to an example implementation. The capacitive sensor device 200 comprises an example implementation of the input device 100 shown in FIG. 1. The capacitive sensor device 200 includes a sensing device 208 coupled to an example implementation of the processing system 110 (referred to as “the processing system 110A”). As used herein, general reference to the processing system 110 is a reference to the processing system described in FIG. 1 or any other embodiment thereof described herein (e.g., the processing system 110A, 110B, etc.).

The sensing device 208 is disposed on a substrate 202 to provide the sensing region 120. The sensing device 208 includes sensor electrodes disposed on the substrate 202. The sensor electrodes function as sensing elements 150 of the sensing device 208. In the present example, the sensing device 208 includes two pluralities of sensor electrodes 220-1 through 220-N (collectively “sensor electrodes 220”), and 230-1 through 230-M (collectively “sensor electrodes 230”), where M and N are integers greater than zero. The sensor electrodes 220 and 230 are separated by a dielectric (not shown). The sensor electrodes 220 and the sensor electrodes 230 can be non-parallel. In an example, the sensor electrodes 220 are disposed orthogonally with the sensor electrodes 230. The orientation of the sensor electrodes 220, 230 is relative to the orientation of the capacitive sensing device 200. For ease of description, the electrodes 220 are shown as the “horizontal” electrodes, and the electrodes 230 are shown as the “vertical” electrodes, such terms being relative and not limiting of any particular geometry.

In some examples, the sensor electrodes 220 and the sensor electrodes 230 can be disposed on separate layers of the substrate 202. In other examples, the sensor electrodes 220 and the sensor electrodes 230 can be disposed on a single layer of the substrate 202. While the sensor electrodes are shown disposed on a single substrate 202, in some embodiments, the sensor electrodes can be disposed on more than one substrate. For example, some sensor electrodes can be disposed on a first substrate, and other sensor electrodes can be disposed on a second substrate adhered to the first substrate.

In the present example, the sensing device 208 is shown with the sensor electrodes 220, 230 generally arranged in a rectangular grid of intersections of orthogonal sensor electrodes. It is to be understood that the sensing device 208 is not limited to such an arrangement, but instead can include numerous sensor patterns. Although the sensing device 208 is depicted as rectangular, the sensing device 208 can have other shapes, such as a circular shape or a non-convex shape.

The processing system 110A can drive the sensor electrodes 220, 230 according to a plurality of excitation schemes, including excitation scheme(s) for transcapacitive sensing. In a transcapacitive excitation scheme, the processing system 110A drives the sensor electrodes 230 with transmitter signals (the sensor electrodes 230 are “transmitter electrodes”), and receives resulting signals from the sensor electrodes 220 (the sensor electrodes 220 are “receiver electrodes”). The sensor electrodes 230 can have the same or different geometry as the sensor electrodes 220. In an example, the sensor electrodes 230 are wider and more closely distributed than the sensor electrodes 220, which are thinner and more sparsely distributed. Alternatively, the sensor electrodes 220, 230 can have the same width and/or the same distribution. In one or more embodiments, each receiver electrode may have one or more segments or prongs.

The sensor electrodes 230 include a plurality of sub-electrodes. In general, each of the sensor electrodes 230 includes at least one discrete portion comprising a set of sub-electrodes. A sensor electrode having one discrete portion is described as having a set of sub-electrodes with one electrode. A sensor electrode having a plurality of discrete portions (referred to as a “subdivided electrode”) is described as having a set of sub-electrodes with a plurality of electrodes. The sub-electrodes are ohmically isolated from one another. At least a portion of the sensor electrodes 230 are subdivided electrodes. Each of the sensor electrodes 230 not subdivided comprises a single electrode (e.g., sensor electrode 230-2).

In the present example, the sensor electrodes 230 include sub-electrodes 225_{1,1} through 225_{X,Y}, where X and Y are integers greater than zero (collectively “sub-electrodes 225”). Thus, the sub-electrodes 225 can form a two-dimensional matrix of electrodes. In other examples, some of the sensor electrodes 230 can include more sub-electrodes than others of the sensor electrodes 230. Thus, the sub-electrodes 225 can form other two-dimensional arrangements than a regular x/y grid and the term “matrix” is meant to encompass various two-dimensional arrangements of the sub-electrodes 225. The sub-electrodes 225 comprise at least a portion of the sub-electrodes included in the sensor electrodes 230 (e.g., some sub-electrodes are not part of the matrix). As used herein, a reference to a sensor electrode 230 in general, or a reference to a particular sensor electrode 230-m (m=1, 2, 3 . . . M), includes all sub-electrodes thereof.

The sensor electrodes 220 and the sensor electrodes 230 are coupled to the processing system 110A by conductive routing traces 204 and conductive routing traces 206, respectively. The processing system 110A is coupled to the sensor electrodes 220, 230 through the conductive routing traces 204, 206 to implement the sensing region 120 for sensing inputs. Each of the sensor electrodes 220 can be coupled to at least one routing trace of the routing traces 206. Likewise, each of the sensor electrodes 230 can be coupled to at least one routing trace of the routing traces 204. In addition, each of the sub-electrodes 225 can be coupled to at least one routing trace of the routing traces 204.

In an embodiment, the routing traces 204 and/or the routing traces 206 are coupled directly to the processing system 110A. The processing system 110A can be configured with enough channels to drive each of the routing traces 204 and/or each of the routing traces 206 individually. In another embodiment, the routing traces 204 are coupled to the processing system 110A through a multiplexer 280, and/or the routing traces 206 are coupled to the processing system 110A through a multiplexer 270. The multiplexer 280 can switch a set of channels of the processing system 110A among a larger set of routing traces 204, and/or the multiplexer 270 can switch a set of channels of the processing system 110A among a larger set of routing traces 206.

The capacitive sensor device 200 can be utilized to communicate user input (e.g., a user's finger, a probe such as a stylus, and/or some other external input object) to an electronic system (e.g., computing device or other electronic device). For example, the capacitive sensor device 200 can be implemented as a capacitive touch screen device that can be placed over an underlying image or information display device (not shown). In this manner, a user would view the underlying image or information display by looking through substantially transparent elements in the sensing device 208. When implemented in a touch screen, the substrate 202 can include at least one substantially transparent layer (not shown). The sensor electrodes 220, 230 and the conductive routing traces 204, 206 can be formed of substantially transparent conductive material. Indium tin oxide (ITO) and/or thin, barely visible wires are but two of many possible examples of substantially transparent material that can be used to form the sensor electrodes 220, 230 and/or the conductive routing traces 204, 206. In other examples, the conductive routing traces 204, 206 can be formed of non-transparent material, and then hidden in a border region (not shown) of the sensing device 208. In still other examples, the routing traces 204, 206 can be made of opaque materials and hidden in a black mask region between display subpixels. In any of the examples, one or more metal layers within the display can be used to route the routing traces 204, 206 to the sensor electrodes.

In another example, the capacitive sensor device 200 can be implemented as a capacitive touchpad, slider, button, or other capacitance sensor. For example, the substrate 202 can be implemented with, but not limited to, one or more clear or opaque materials. Likewise, clear or opaque conductive materials can be utilized to form sensor electrodes and/or conductive routing traces for the sensing device 208.

In general, the processing system 110A excites or drives sensing elements (e.g., sensor electrode(s) and/or sub-electrode(s)) of the sensing device 208 with a capacitive sensing signal and measures an induced or resulting signal. The terms “excite” and “drive” as used herein encompasses controlling some electrical aspect of the driven element. For example, it is possible to drive current through a wire, drive charge into a conductor, drive a substantially constant or varying voltage waveform onto an electrode, etc. A capacitive sensing signal can be constant, substantially constant, or varying over time, and generally includes a shape, frequency, amplitude, and phase. A capacitive sensing signal can be referred to as an “active signal” as opposed to a “passive signal,” such as a ground signal or other reference signal. A capacitive sensing signal can also be referred to as a “transmitter signal” when used in transcapacitive sensing, or an “absolute capacitive sensing signal” or “modulated signal” when used in absolute sensing.

In an example, the processing system 110A drives sensing element(s) of the sensing device 208 with a voltage and senses resulting respective charge on sensing element(s). That is, the capacitive sensing signal is a voltage signal and the resulting signal is a charge signal (e.g., a signal indicative of accumulated charge, such as an integrated current signal). Capacitance is proportional to applied voltage and inversely proportional to accumulated charge. The processing system 110A can determine measurement(s) of capacitance from the sensed charge. In another example, the processing system 110A drives sensing element(s) of the sensing device 208 with charge and senses resulting respective voltage on sensing element(s). That is, the capacitive sensing signal is a signal to cause accumulation of charge (e.g., current signal) and the resulting signal is a voltage signal. The processing system 110A can determine measurement(s) of capacitance from the sensed voltage. In general, the term “capacitive sensing signal” is meant to encompass both driving voltage to sense charge and driving charge to sense voltage, as well as any other type of signal that can be used to obtain indicia of capacitance. “Indicia of capacitance” include measurements of charge, current, voltage, and the like, as well as measurements of a change in charge, current, voltage, and the like with respect to a baseline, from which capacitance or change in capacitance can be derived.

The processing system 110A can include a sensor module 240, a capacitive measurer module 250, and a position determiner module 260. The sensor module 240, the capacitive measurer module 250, and the position determiner module 260 comprise modules that perform different functions of the processing system 110A. In other examples, different configurations of modules can perform the functions described herein. The sensor module 240, the capacitive measurer module 250, and the position determiner module 260 can include sensor circuitry 275 and can also include firmware, software, or a combination thereof operating in cooperation with the sensor circuitry 275.

The sensor module 240 selectively drives signal(s) on one or more sensing elements of the sensing device 208 over one or more cycles (“excitation cycles”) in accordance with one or more schemes (“excitation schemes”). Each excitation cycle has an associated time period during which signals are driven and measured. During each excitation cycle, the sensor module 240 can selectively sense resulting signal(s) from one or more sensing elements of the sensing device 208.

In one type of excitation scheme, the sensor module 240 can selectively drive sensing elements of the sensing device 208 for absolute capacitive sensing. In absolute capacitive sensing, the sensor module 240 drives selected sensing element(s) with an absolute capacitive sensing signal and senses resulting signal(s) from the selected sensing element(s). In such an excitation scheme, measurements of absolute capacitance between the selected sensing element(s) and input object(s) are determined from the resulting signal(s). In an example, the sensor module 240 can drive selected sensor electrodes 220, and/or selected sensor electrodes 230, with an absolute capacitive sensing signal. In another example, the sensor module 240 can drive selected sub-electrodes 225 with an absolute capacitive sensing signal.

In another type of excitation scheme, the sensor module 240 can selectively drive sensing elements of the sensing device 208 for transcapacitive sensing. In transcapacitive sensing, the sensor module 240 drives selected transmitter sensor electrodes with transmitter signals and senses resulting signals from selected receiver sensor electrodes. In such an excitation scheme, measurements of transcapacitance between transmitter and receiver electrodes are determined from the resulting signals. In an example, the sensor module 240 can drive the sensor electrodes 230 with transmitter signals and receive resulting signals on the sensor electrodes 220.

In any excitation cycle, the sensor module 240 can drive sensing elements of the sensing device 208 with other signals, including reference signals and guard signals. That is, those sensing elements of the sensing device 208 that are not driven with a capacitive sensing signal, or sensed to receive resulting signals, can be driven with a reference signal, a guard signal, or left floating (i.e., not driven with any signal). A reference signal can be a ground signal (e.g., system ground) or any other constant or substantially constant voltage signal. A guard signal can be a signal that is similar or the same in at least one of shape, amplitude, frequency, or phase of a transmitter signal. Electrically floating an electrode can be interpreted as a form of guarding in cases where, by floating, the electrode receives a desired guard signal via capacitive coupling from another electrode.

“System ground” may indicate a common voltage shared by system components. For example, a capacitive sensing system of a mobile phone can, at times, be referenced to a system ground provided by the phone's power source (e.g., a charger or battery). The system ground may not be fixed relative to earth or any other reference. For example, a mobile phone on a table usually has a floating system ground. A mobile phone being held by a person who is strongly coupled to earth ground through free space may be grounded relative to the person, but the person-ground may be varying relative to earth ground. In many systems, the system ground is connected to, or provided by, the largest area electrode in the system. The capacitive sensor device 200 can be located proximate to such a system ground electrode (e.g., located above a ground plane or backplane).

The capacitive measurer module 250 performs capacitance measurements based on resulting signals obtained by the sensor module 240. The capacitance measurements can include changes in capacitive couplings between elements (also referred to as “changes in capacitance”). For example, the capacitive measurer module 250 can determine baseline measurements of capacitive couplings between elements without the presence of external input object(s). The capacitive measurer module 250 can then combine the baseline measurements of capacitive couplings with measurements of capacitive couplings in the presence of external input object(s) to determine changes in capacitive couplings. In another example, the sensor module 240 provides indicia of capacitance that already accounts for the baseline, and thus the capacitive measurer module 250 can determine changes in capacitance directly from such indicia of capacitance.

In an example, the capacitive measurer module 250 can perform a plurality of capacitance measurements associated with specific portions of the sensing region 120 as “pixels” to create a “capacitive image” or “capacitive frame.” A pixel of a capacitive image can be referred to as a location within the sensing region 120 in which a capacitive coupling can be measured using sensing elements of the sensing device 208. For example, a pixel can correspond to a transcapacitive coupling between a sensor electrode 220 and a sensor electrode 230 affected by input object(s). When performing transcapacitive sensing, sub-electrodes 225 of those sensor electrodes 230 that are subdivided can be driven simultaneously as a group to effectively form a single electrode 230. In another example, a pixel can correspond to an absolute capacitive coupling between a sub-electrode 225 and input object(s). When performing such absolute capacitive sensing, the sub-electrodes 225 are driven individually. The capacitive measurer module 250 can determine an array of capacitive coupling changes using the sensing elements of the sensing device 208 to produce an x/y array of pixels that form a capacitive image. The capacitive image can be obtained using transcapacitive sensing (e.g., transcapacitive image), or obtained using absolute capacitive sensing (e.g., absolute capacitive image). In this manner, the processing system 110A can capture a capacitive image that is a snapshot of the response measured in relation to input object(s) in the sensing region 120. A given capacitive image can include all of the pixels in the sensing region, or only a subset of the pixels.

In another example, the capacitive measurer module 250 can perform a plurality of capacitance measurements associated with a particular axis of the sensing region 120 to create a “capacitive profile” along that axis. The capacitive measurer module 250 can determine an array of absolute capacitive coupling changes along the sensor electrodes 220 and/or the sensor electrodes 230 to produce a capacitive profile along the respective axis or axes. The array of capacitive coupling changes can include a number of points less than or equal to the number of sensor electrodes along the given axis. In the profile-based absolute sensing scheme, sub-electrodes 225 of those sensor electrodes 230 that are subdivided can be driven simultaneously as a group to effectively form a single electrode 230.

The sensor module 240 and the capacitive measurer module 250 can cooperate to obtain measurements of either absolute capacitance, transcapacitance, or a combination thereof. The processing system 110A can operate in multiple modes. The processing system 110A can operate in a first mode to detect input object(s) using transcapacitive sensing, and in a second mode to detect input object(s) using absolute capacitive sensing. In the first mode, the processing system 110A can employ one or more excitation schemes to obtain measurements of transcapacitance and produce a capacitive image. In the second mode, the processing system 110A can employ one or more excitation schemes to obtain measurements of absolute capacitance and produce a capacitive image or capacitive profile(s).

Measurement(s) of capacitance by the processing system 110A, such as capacitive image(s) or capacitive profile(s), enable the sensing of contact, hovering, or other user input with respect to the formed sensing regions by the sensing device 208. The position determiner module 260 can utilize the measurement(s) of capacitance to determine positional information with respect to a user input relative to the sensing regions formed by the sensing device 208. The position determiner module 260 can additionally or alternatively use such measurement(s) to determine input object size, shape, and/or input object type.

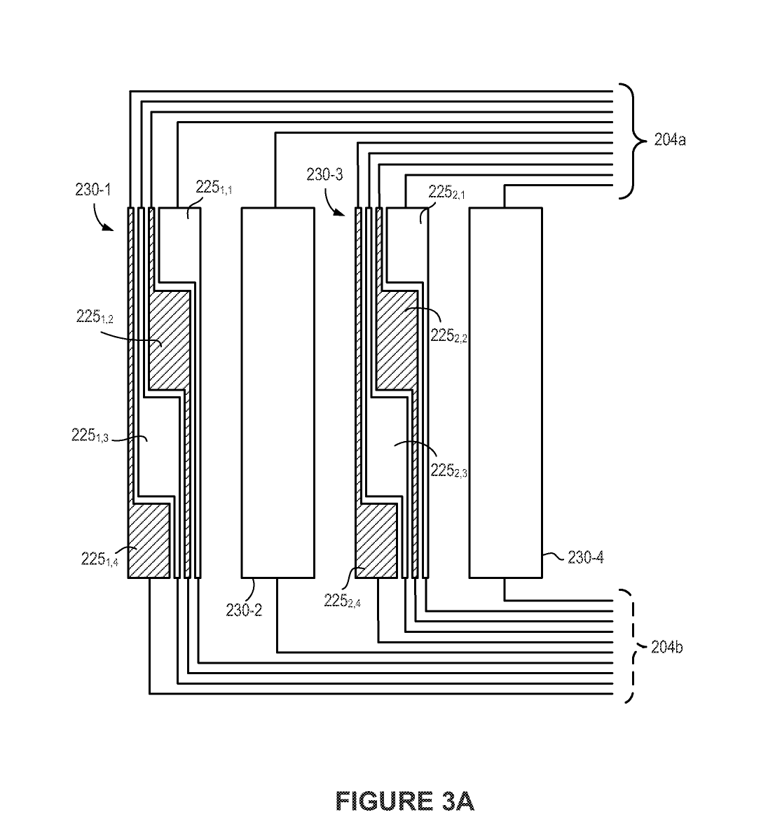

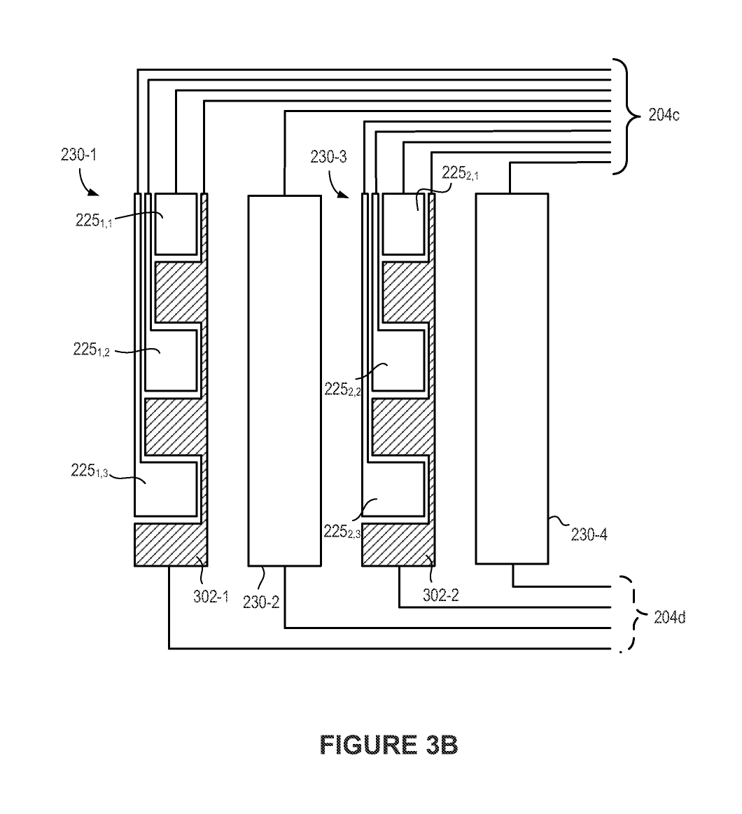

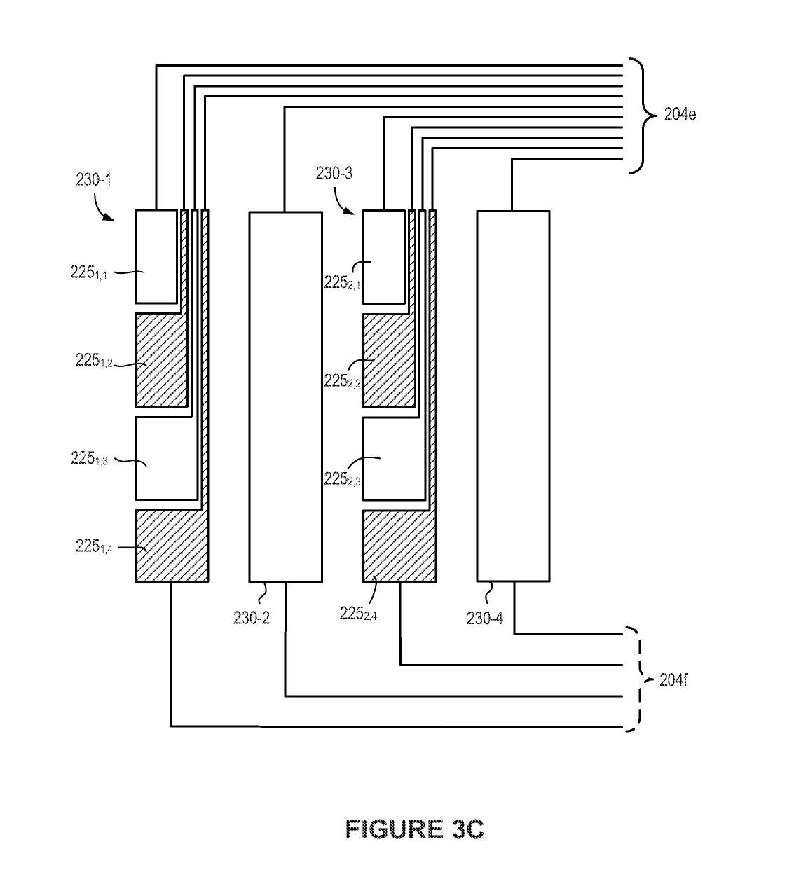

FIGS. 3A-3C show configurations of the sensor electrodes 230 and sub-electrodes 225 according to example implementations. The example configurations show four of the sensor electrodes 230, e.g., the sensor electrodes 230-1 through 230-4. Any remaining sensor electrodes 230-5 through 230-M can be configured similarly by repeating the pattern. The sensor electrodes 230-1 and 230-3 comprise subdivided electrodes each having a plurality of sub-electrodes 225. Alternating sub-electrodes are shown in cross-hatch to visually distinguish sub-electrode boundaries. The sensor electrodes 230-2 and 230-4 are not subdivided (e.g., each respective set of sub-electrodes includes a single electrode). In the examples, each of the sensor electrodes 230-1 through 230-4 is rectangular in shape having a first end and a second end. Each set of sub-electrodes, as a group, generally conforms to the shape of a sensor electrode 230. Each sub-electrode includes a first end and a second end. The first ends of the sub-electrodes in a given set of sub-electrodes are exposed at the first end of the respective sensor electrode 230. In some examples, at least one sub-electrode in a given set of sub-electrodes has a second end exposed at the second end of the respective sensor electrode 230.

The first ends of the electrodes 230-1 through 230-4 are coupled to routing traces of the routing traces 204. For the subdivided electrodes (e.g., the sensor electrodes 230-1 and 230-2), each exposed first end of the sub-electrodes is coupled to a separate routing trace. In some examples, the second ends of the electrodes 230-1 through 230-4 are coupled to additional routing traces of the routing traces 204. For the subdivided electrodes, each exposed second end of the sub-electrodes (if any) is coupled to a separate routing trace. A given electrode coupled to a routing trace at one end can have a signal applied at the one end (“single-ended drive”). A given electrode coupled to routing traces at both ends can have signals applied at both ends (“double-ended drive”). For an electrode configured for double-ended drive, the signals applied at the ends can be the same or can be different to establish a gradient across the electrode.

Although the examples of FIGS. 3A-3C show various electrodes and sub-electrodes as being coupled to routing traces at two ends, such a double-ended drive configuration is optional. In one or more other embodiments, the electrodes and sub-electrodes can be coupled to routing traces at a single end. Moreover, while the electrodes and sub-electrodes are shown having an elongated area that is used to route the electrode/sub-electrodes, in other examples the electrodes and sub-electrodes can have other shapes, such as thin metal wires disposed on the same layer or multiple layers.

In the example configurations, every other one of the sensor electrodes 230 is subdivided into four sub-electrodes. In general, the sensor electrodes 230 can include at least one electrode subdivided into a plurality of sub-electrodes. Some sensor electrode(s) 230 can have a different number of sub-electrodes than other(s) of the sensor electrodes 230. In a given configuration, the subdivided ones of the sensor electrodes 230 can be separated by zero or more undivided ones of the sensor electrodes 230. Thus, in an example, every one of the sensor electrodes 230 is subdivided into a plurality of sub-electrodes. In another example, multiple undivided electrodes are disposed between subdivided electrodes. The subdivided electrodes can be in different positions among the sensor electrodes 230 (e.g., evenly distributed throughout the sensor electrodes 230, distributed more to the left, right, or center, etc.). Although the sensor electrodes 230 are shown as being generally rectangular, the sensor electrodes 230 can have other shapes and the sets of sub-electrodes can generally conform to such other shapes.

Referring to the example configuration shown in FIG. 3A, the sensor electrodes 230-1 and 230-3 comprise subdivided electrodes each having four of the sub-electrodes 225. The sensor electrode 230-1 is subdivided into the sub-electrodes 225_{1,1} through 225_{1,4}, and the sensor electrode 230-3 is subdivided into the sub-electrodes 225_{2,1} through 225_{2,4}. The sensor electrodes 230-2 and 230-4 are not subdivided and each includes a single portion. Both ends of each sub-electrode 225 are exposed, allowing for double-ended driving schemes in some examples. The first ends of the electrodes 230-1 through 230-4 are coupled to routing traces 204a of the routing traces 204. In some examples, the second ends of the electrodes 230-1 through 230-4 are coupled to additional routing traces 204b of the routing traces 204. The routing traces 204a and 204b can have different numbers of routing traces, depending on the configuration of the sub-electrodes 225.

In an example, each sub-electrode 225 is coupled to a routing trace of the routing traces 204a. In another example, the ends of each sub-electrode 225 are coupled to routing traces of the routing traces 204a and 204b, respectively. Each of the sub-electrodes 225 includes a first generally rectangular portion, and at least one other generally rectangular portion extending from at least one edge of the first rectangular portion and being thinner in width than the first rectangular portion. The sub-electrodes in a given set can be interleaved to conform to the shape of a sensor electrode 230. AH sub-electrodes in a given set can have substantially the same surface area, or some sub-electrodes in a given set can differ in surface area. All sub-electrodes in a given set can have the same size and shape, or some sub-electrodes in a given set can differ in at least one of size or shape.

Referring to the example configuration shown in FIG. 3B, the sensor electrodes 230-1 and 230-3 comprise subdivided electrodes each having four sub-electrodes. The sensor electrode 230-1 is subdivided into the sub-electrodes 225_{1,1} through 225_{1,3} and a sub-electrode 302-1, and the sensor electrode 230-3 is subdivided into the sub-electrodes 225_{2,1} through 225_{2,3} and a sub-electrode 302-2. The sensor electrodes 230-2 and 230-4 are not subdivided and each includes a single portion. One end of each sub-electrode 225 of the sensor electrodes 230-1 and 230-3 is exposed. Both ends of the sub-electrodes 302-1 and 302-2 are exposed. The first ends of the electrodes 230-1 through 230-4 are coupled to routing traces 204c of the routing traces 204. In some examples, the second ends of the electrodes 230-1 through 230-4 are coupled to additional routing traces 204d of the routing traces 204. The routing traces 204c and 204d can have different numbers of routing traces, depending on the configuration of the sub-electrodes 225.

In an example, each sub-electrode 225 and 302-1 of the sensor electrode 230-1 is coupled to a routing trace of the routing traces 204c, and each sub-electrode 225 and 302-2 of the sensor electrode 230-2 is coupled to a routing trace of the routing traces 204c. In an example, other ends of the sub-electrodes 302-1 and 302-2 can be coupled to respective routing traces of the routing traces 204d. Each of the sub-electrodes 225 includes a first generally rectangular portion and a second generally rectangular portion extending from one edge of the first rectangular portion and being thinner in width than the first rectangular portion. Each of the sub-electrodes 302-1 and 302-2 comprises a plurality of generally rectangular portions distributed to form notches in which the first rectangular portions of the sub-electrodes 225 are disposed. All sub-electrodes 225 in a given set can have substantially the same surface area, or some sub-electrodes 225 in a given set can differ in surface area. All sub-electrodes 225 in a given set can have the same size and shape, or some sub-electrodes 225 in a given set can differ in at least one of size or shape.

FIG. 3B shows an example where not all of the sub-electrodes are part of the matrix formed by the sub-electrodes 225. In a given excitation scheme, the sub-electrodes 302-1 and 302-2 may be driven differently than the sub-electrodes 225. For example, the sub-electrodes 302-1 and 302-2 may be driven with a capacitive sensing signal in a transcapacitive excitation scheme, but with another signal (e.g., a guard signal or reference signal) or left floating in an absolute capacitive excitation scheme.

Referring to the example configuration shown in FIG. 3C, the sensor electrodes 230-1 and 230-3 comprise subdivided electrodes each having four of the sub-electrodes 225. The sensor electrode 230-1 is subdivided into the sub-electrodes 225_{1,1} through 225_{1,4}, and the sensor electrode 230-3 is subdivided into the sub-electrodes 225_{2,1} through 225_{2,4}. The sensor electrodes 230-2 and 230-4 are not subdivided and each includes a single portion. Both ends of the sub-electrodes 225_{1,4} and 225_{2,4} are exposed. One end of each of the sub-electrodes 225_{1,1} through 225_{1,3} and the sub-electrodes 225_{2,1} through 225_{2,3} is exposed. The first ends of the electrodes 230-1 through 230-4 are coupled to routing traces 204e of the routing traces 204. In some examples, the second ends of the electrodes 230-1 through 230-4 are coupled to additional routing traces 204f of the routing traces 204. The routing traces 204e and 204f can have different numbers of routing traces, depending on the configuration of the sub-electrodes 225.

In an example, each sub-electrode 225 is coupled to a routing trace of the routing traces 204e. In another example, the ends of each sub-electrode 225 are coupled to routing traces of the routing traces 204e and 204f, respectively. Each of the sub-electrodes 225 includes a first generally rectangular portion and second generally rectangular portion extending from an edge of the first rectangular portion and being thinner in width than the first rectangular portion. The sub-electrodes in a given set can be interleaved to conform to the shape of a sensor electrode 230. All sub-electrodes in a given set can have substantially the same surface area, or some sub-electrodes in a given set can differ in surface area. All sub-electrodes in a given set can have the same size and shape, or some sub-electrodes in a given set can differ in at least one of size or shape.

FIGS. 3A-3C show three examples of a myriad of possible configurations of sub-electrodes formed within the sensor electrodes 230. The sub-electrodes can have different shapes and/or sizes, sensor electrodes 230 can include more or less sub-electrodes, sub-divided electrodes can be separated by more or less undivided electrodes, and some subdivided electrodes can include more or less sub-electrodes than other subdivided electrodes. Further, some subdivided electrodes can have sub-electrodes of different shape and/or size than sub-electrodes of other subdivided electrodes. That is, a given sensing device 208 can include any combination of the patterns shown in FIGS. 3A, 3B, and 3C, and/or any other pattern.

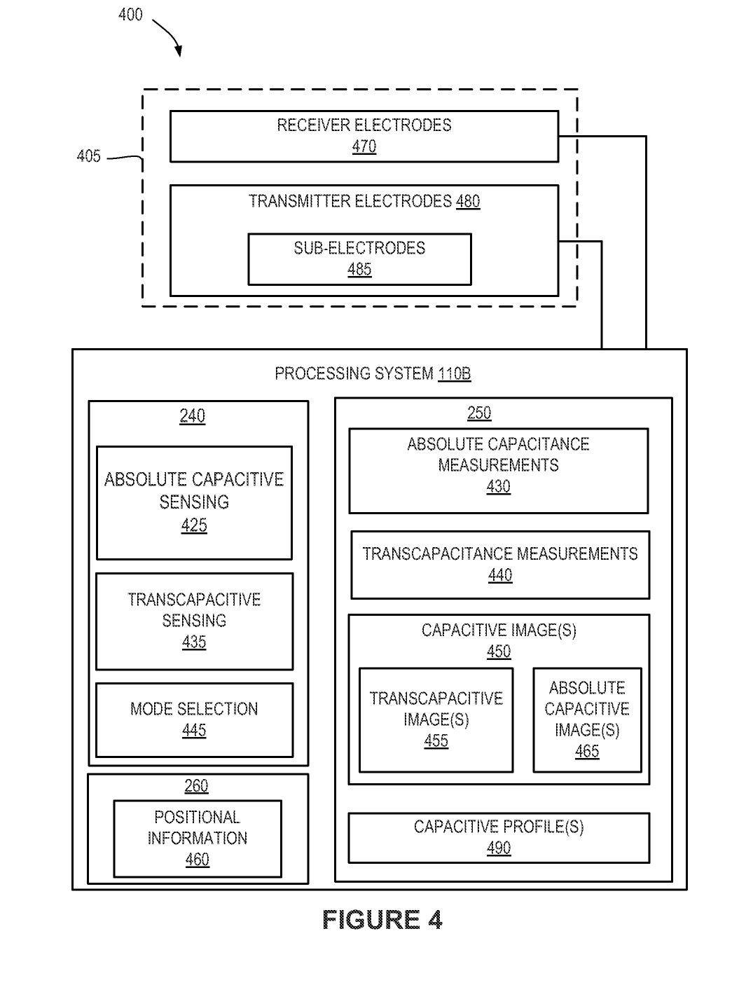

FIG. 4 is a block diagram depicting a capacitive sensor device 400 according to an example implementation. The capacitive sensor device 400 is an example implementation of the input device 100. The capacitive sensor device 400 includes sensor electrodes 405 coupled to an example implementation of the processing system 110 (“the processing system 110B”). The sensor electrodes 405 include receiver electrodes 470 and transmitter electrodes 480. The receiver electrodes 470 are non-parallel to (e.g., orthogonal to) the transmitter electrodes 480. The transmitter electrodes 480 include sub-electrodes 485.

The sensor module. 240 includes an absolute capacitance sensing module 425 for driving the sensor electrodes 405 using absolute capacitive excitation scheme(s), a transcapacitive sensing module 435 for driving the sensor electrodes 405 using transcapacitive excitation scheme(s), and a mode selection module 445. In particular, the transcapacitive sensing module 435 drives one or more of the transmitter electrodes 480 with transmitter signal(s), and receives resulting signals on the receiver electrodes 470. For those transmitter electrodes 480 that are subdivided, the respective sub-electrodes 485 can be driven with a transmitter signal simultaneously as a group. Those of the sensor electrodes 405 that are not driven with transmitter signal(s) or sensed to receive resulting signals can be driven with a reference signal, a guard signal, or left floating.

The transcapacitive sensing module 435 can perform one or more excitation cycles, each with different sensor electrode(s) being driven with transmitter signal(s). The transcapacitive sensing module 435 can provide transcapacitive results obtained in each of the excitation cycle(s) to the capacitive measurer module 250, which determines transcapacitance measurements 440. The capacitive measurer module 250 can determine transcapacitive mage(s) 455 from the transcapacitance measurements 440.

The absolute capacitance sensing module 425 drives one or more of the sensor electrodes 405 with an absolute capacitive sensing signal. Those of the sensor electrodes 405 that are not driven with an absolute capacitive sensing signal can be driven with a reference signal, a guard signal, or left floating (i.e., not driven with any signal). In one excitation scheme, the absolute capacitance sensing module 425 can drive one or more of the sub-electrodes 485 with an absolute capacitive sensing signal. The absolute capacitance sensing module 425 can perform one or more excitation cycles of such an excitation scheme. The absolute capacitance sensing module 425 can provide absolute capacitive results obtained in each of the excitation cycle(s) to the capacitive measurer module 250, which determines absolute capacitance measurements 430. The capacitive measurer module 250 can determine absolute capacitive image(s) 465 from the absolute capacitive measurements 430.

In another excitation scheme, the absolute capacitance sensing module 425 can drive one or more of the electrodes 470, 480 with an absolute capacitive sensing signal. For those sensor electrodes 480 that are subdivided, the respective sub-electrodes 485 can be driven with an absolute capacitive sensing signal simultaneously as a group. The absolute capacitance sensing module 425 can perform one or more excitation cycles of such an excitation scheme. The absolute capacitance sensing module 425 can provide absolute capacitive results obtained in each of the excitation cycle(s) to the capacitive measurer module 250, which determines absolute capacitance measurements 430. The capacitive measurer module 250 can determine capacitive profiles 490 from the absolute capacitive measurements 430.

Thus, the capacitive measurer module 250 generates capacitive image(s) 450 and/or capacitive profile(s) 490. The position determiner module 260 can determine the position information 460 from the capacitive image(s) 450 and/or capacitive profile(s) 490.

The mode selection module 445 can control which of one or more excitation schemes the sensor module 240 will employ to obtain capacitance measurements. The mode selection module 445 can be part of the sensor module 240 as shown, can be part of another module (e.g., the capacitive measurer module 250), or can be a separate module in the processing system 110B. The mode selection module 445 can dynamically switch between first and second modes. In the first mode, the mode selection module 445 controls the sensor module 240 to implement one or more transcapacitive excitation schemes to obtain transcapacitive image(s). In the second mode, the mode selection module 445 controls the sensor module 240 to drive the sub-electrodes 485 with one or more absolute capacitive excitation schemes to obtain absolute capacitive image(s).

The mode selection module 445 can cause the sensor module 240 to switch excitation schemes based on the resulting signals received by the current excitation scheme. For example, the mode selection module 445 can invoke the first mode using transcapacitive sensing. If the resulting signals do not satisfy defined threshold(s), the mode selection module 445 can invoke the second mode to drive the sub-electrodes 485 for absolute sensing.

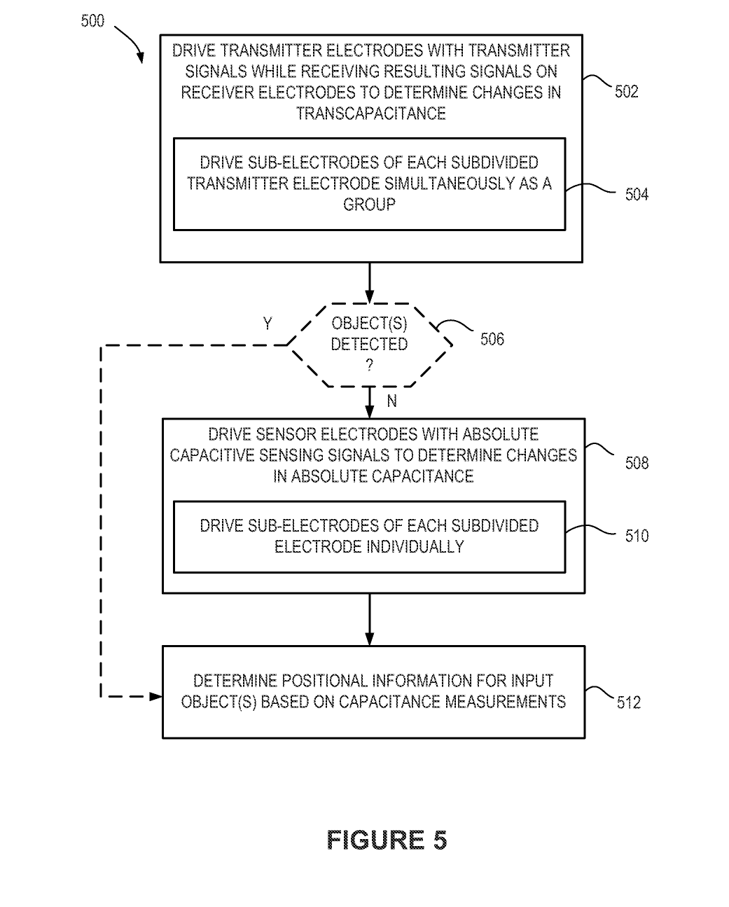

FIG. 5 is a flow diagram showing a method 500 of driving sensor electrodes for capacitive sensing according to an example implementation. Aspects of the method 500 can be understood with reference to the example capacitive sensing device 400 of FIG. 4 by way of example and not limitation. The method 500 begins at step 502, where the sensor module 240 drives the transmitter electrodes 480 with transmitter signals while receiving resulting signals on the receiver electrodes 470 to determine changes in transcapacitance. The step 502 can include a step 504, where sub-electrodes 485 of each subdivided transmitter electrode 480 are driven simultaneously as a group.

In an example, the method 500 proceeds to step 508. At step 508, the sensor module 240 drives the electrodes 405 with absolute capacitive sensing signals to determine changes in absolute capacitance. The step 508 can include a step 510, where sub-electrodes 485 of each subdivided transmitter electrode 480 are driven individually with an absolute capacitive sensing signal. At step 512, the position determiner module 260 determines positional information for input objects) based on capacitance measurements.

In another example, the method 500 proceeds from step 502 to optional step 506. At optional step 506, the processing system 110B determines whether an input object has been detected at step 502. If so, the method 500 can proceed directly to step 512, where the position determiner module 260 determines positional information for input objects) based on transcapacitance measurements. If an input object is not detected at optional step 506, the method 500 proceeds to the step 508. In such case, at step 512, the position determiner module 260 can determine positional information for input object(s) based on absolute capacitance measurements. The processing system 110B can implement various threshold(s) to determine if an input object has been detected at step 502. For example, the processing system 110B can compare a maximum transcapacitive measurement with a threshold. If the maximum transcapacitive measurement is less than the threshold, the method 500 can proceed to step 508 and employ absolute sensing using the sub-electrodes 485.

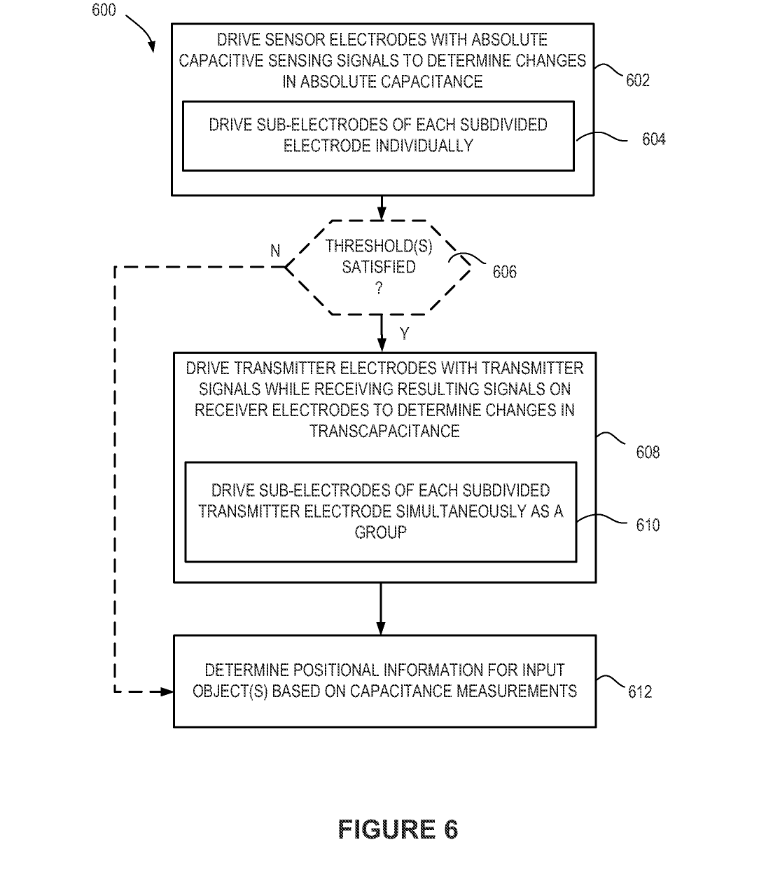

FIG. 6 is a flow diagram showing a method 600 of driving sensor electrodes for capacitive sensing according to an example implementation. Aspects of the method 600 can be understood with reference to the example capacitive sensing device 400 of FIG. 4 by way of example and not limitation. The method 600 begins at step 602, where the sensor module 240 drives the electrodes 405 with absolute capacitive sensing signals to determine changes in absolute capacitance. The step 602 can include a step 604, where sub-electrodes 485 of each subdivided transmitter electrode 480 are driven individually with an absolute capacitive sensing signal.

In an example, the method 600 proceeds to step 608, where the sensor module 240 drives the transmitter electrodes 480 with transmitter signals while receiving resulting signals on the receiver electrodes 470 to determine changes in transcapacitance. The step 608 can include a step 610, where sub-electrodes 485 of each subdivided transmitter electrode 480 are driven simultaneously as a group. At step 612, the position determiner module 260 determines positional information for input object(s) based on capacitance measurements.

In another example, the method 600 proceeds from step 602 to optional step 606. At optional step 606, the processing system 110B determines whether the absolute capacitance measurements satisfy one or more thresholds. If not, the method 600 can proceed directly to step 612, where the position determiner module 260 determines positional information for input object(s) based on absolute capacitance measurements. If the absolute capacitance measurements satisfy threshold(s) at optional step 606, the method 600 proceeds to the step 608. In such case, at step 612, the position determiner module 260 can determine positional information for input object(s) based on transcapacitance measurements, absolute capacitance measurements, or a combination thereof. The processing system 110B can implement various threshold(s) at step 606. For example, the processing system 110B can compare a minimum absolute capacitance measurement and/or average absolute capacitance measurement with a threshold. If the minimum/average absolute capacitance measurement is greater than the threshold, the method 600 can proceed to step 608 and employ transcapacitive sensing.

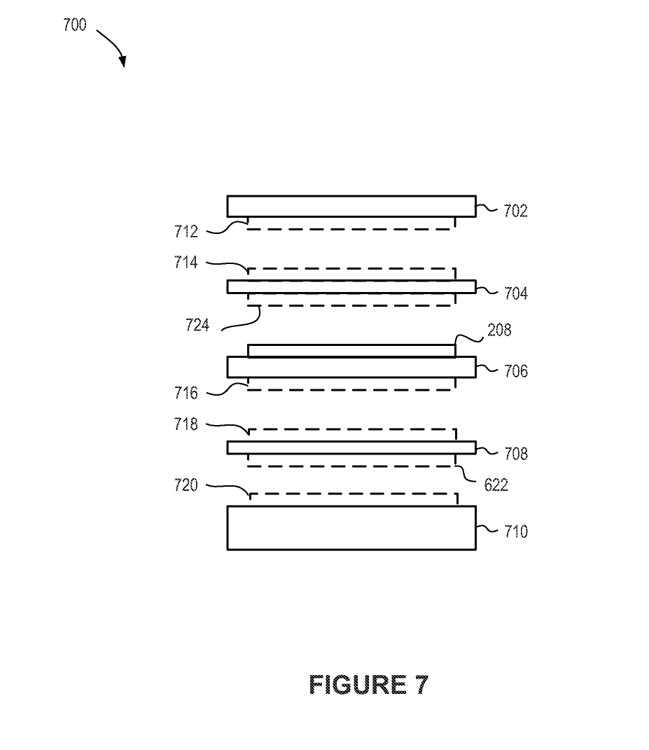

FIG. 7 is an exploded side view of a display device 700 having an integrated input device according to an example implementation. FIG. 7 shows alternative locations for a layer having both the receiver and transmitter electrodes 220, 230 of the sensing device 208. The display device 700 generally includes a plurality of transparent substrates over a substrate 710 (e.g., thin-film transistor (TFT) glass). In an example, the transparent substrates include a lens 702, an optional polarizer 704, a color filter glass 706, and a color filter 708. In one example, the sensing device 208 is disposed on a surface of the color filter glass 706 between the color filter glass 706 and the optional polarizer 704. Alternative locations for the sensing device 208 are shown in phantom and include a location 720 on a surface of the substrate 710, locations 718 or 722 on a surface of the color filter 708, a location 716 the other surface of the color filter glass 706 facing the color filter 708, locations 714 or 724 on a surface of the optional polarizer 704, or a location 712 on a surface of the lens 702 facing the optional polarizer 704. The transmitter electrodes 230 are disposed on the same layer as the receiver electrodes 220. The transmitter electrodes 230 are insulated from the receiver electrodes 220 in cross regions. The sensing device 208 can be disposed on (1) a separate transparent substrate, (2) at least partially on or fully formed on one of the substrates of the display device 700, or (3) at least partially on, fully formed on, or within an active element of the display device 700.

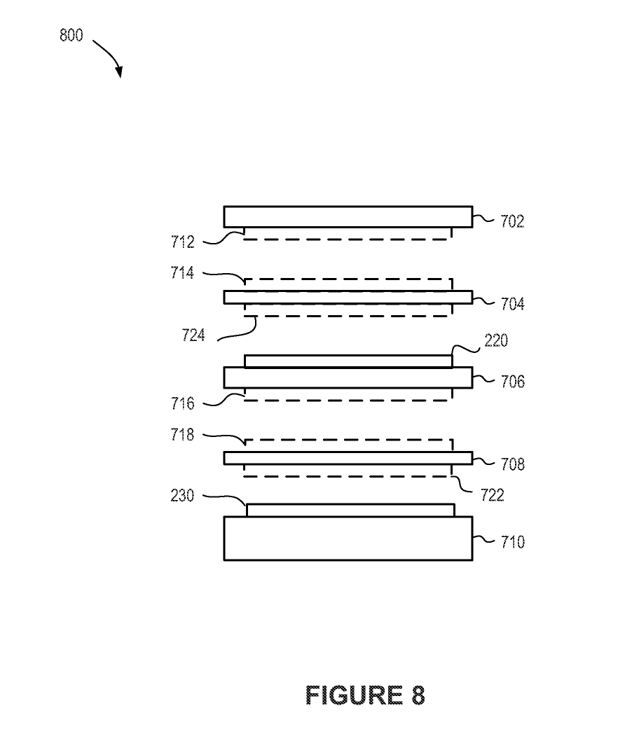

FIG. 8 is an exploded side view of a display device 800 having an integrated input device according to an example implementation. In the display device 800, the transmitter electrodes 230 are disposed on a different layer than the receiver electrodes 220. In one example, the receiver electrodes 220 are disposed on a surface of the color filter glass 706 facing the optional polarizer 704, and the transmitter electrodes 230 are disposed on the substrate 710 facing the color filter 708. Alternative locations for the transmitter electrodes 230 and the receiver electrodes 220 are shown in phantom and include the locations 718 or 722 on a surface of the color filter 708, the location 716 the other surface of the color filter glass 706 facing the color filter 708, the locations 714 or 724 on a surface of the optional polarizer 704, or the location 712 on a surface of the lens 702 facing the optional polarizer 704. The transmitter electrodes 230 and the receiver electrodes 220 can be disposed on (1) a separate transparent substrate, (2) at least partially on or fully formed on one of the substrates of the display device 800, or (3) at least partially on, fully formed on, or within an active element of the display device 800.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. An input device, comprising:
a plurality of transmitter electrodes including: a first transmitter electrode having a first set of sub-electrodes; and a second transmitter electrode having a second set of sub-electrodes, where the number of sub-electrodes in the first set is different than the number of sub-electrodes in the second set;
a plurality of receiver electrodes; and
a processing system, coupled to the plurality of transmitter electrodes and the plurality of receiver electrodes, the processing system configured to:
drive, in a first mode, the plurality of transmitter electrodes with transmitter signals while receiving resulting signals from the plurality of receiver electrodes to determine changes in transcapacitance; and
drive, in a second mode, the plurality of transmitter electrodes with absolute capacitive sensing signals to determine changes in absolute capacitance.

2. The input device of claim 1, wherein the processing system is configured to, in the first mode, simultaneously drive the first set of sub-electrodes of the first transmitter electrode with a transmitter signal as a group.

3. The input device of claim 1, wherein the processing system is configured to, in the second mode, individually drive each sub-electrode in the first set of sub-electrodes with an absolute capacitive sensing signal to acquire a change in absolute capacitance for each sub-electrode in the first set of sub-electrodes.

4. The input device of claim 1, wherein the first set of sub-electrodes comprises a plurality of sub-electrodes, and the second set of sub-electrodes comprises a single electrode.

5. The input device of claim 1, wherein each of the first and second sets of sub-electrodes comprises a respective plurality of sub-electrodes, the first set of sub-electrodes having more sub-electrodes than the second set of sub-electrodes.

6. The input device of claim 1, wherein the input device includes a plurality of layers, and the plurality of transmitter electrodes are disposed on a different layer than the plurality of receiver electrodes.

7. The input device of claim 1, wherein the input device includes at least one layer, and the plurality of transmitter electrodes are disposed on a same layer as the plurality of receiver electrodes.

8. The input device of claim 1, wherein each of the sub-electrodes in the first set of sub-electrodes have substantially the same surface area.

9. The input device of claim 1, wherein at least two sub-electrodes in the first set of sub-electrodes differ in at least one of size or shape.

10. The input device of claim 1, further comprising:
a multiplexer;
wherein each sub-electrode in the first set of sub-electrodes is coupled to the multiplexer by an individual routing trace, the first set of sub-electrodes being coupled to the processing system through the multiplexer.

11. The input device of claim 1, wherein each sub-electrode in the first set of sub-electrodes is coupled to the processing system by an individual routing trace.

12. A method of driving transmitter electrodes and receiver electrodes for capacitive sensing, comprising:
driving, in a first mode, a the transmitter electrodes with transmitter signals while receiving resulting signals from the receiver electrodes to determine changes in transcapacitance, the transmitter electrodes including: a first transmitter electrode having a first set of sub-electrodes; and a second transmitter electrode having a second set of sub-electrodes, where the number of sub-electrodes in the first set is different than the number of sub-electrodes in the second set; and
driving, in a second mode, the transmitter electrodes with absolute capacitive sing signals to determine changes in absolute capacitance.

13. The method of claim 12, wherein the step of driving in the first mode includes:
driving the first set of sub-electrodes of the first transmitter electrode simultaneously with a transmitter signal as a group.

14. The method of claim 12, wherein the step of driving in the second mode includes:
driving, individually, each sub-electrode in the first set of sub-electrodes with an absolute capacitive sensing signal to acquire a change in absolute capacitance for each sub-electrode in the first set of sub-electrodes.

15. The method of claim 12, wherein the first set of sub-electrodes comprises a plurality of sub-electrodes, and the second set of sub-electrodes comprises a single electrode.

16. The method of claim 12, wherein each of the first and second sets of sub-electrodes comprises a respective plurality of sub-electrodes, the first set of sub-electrodes having more sub-electrodes than the second set of sub-electrodes.

17. A processing system, comprising:
a sensor module comprising sensor circuitry, the sensor module configured to:
drive, in a first mode, a plurality of transmitter electrodes with transmitter signals while receiving resulting signals from a plurality of receiver electrodes to determine changes in transcapacitance, the plurality of transmitter electrodes including: a first transmitter electrode having a first set of sub-electrodes; and a second transmitter electrode having a second set of sub-electrodes, where the number of sub-electrodes in the first set is different than the number of sub-electrodes in the second set; and
drive, in a second mode, the plurality of transmitter electrodes with absolute capacitive sensing signals to determine changes in absolute capacitance; and
a determination module configured to determine positional information for at least one input object based on changes in capacitance determined by the sensor module.

18. The processing system of claim 17, wherein the sensor module is configured to, in the first mode, simultaneously drive the first set of sub-electrodes of the first transmitter electrode with a transmitter signal as a group.

19. The processing system of claim 17, wherein the sensor module is configured to, in the second mode, individually drive each sub-electrode in the first set of sub-electrodes with an absolute capacitive sensing signal to acquire a change in absolute capacitance for each sub-electrode in the first set of sub-electrodes.

20. The processing system of claim 17, wherein the first set of sub-electrodes comprises a plurality of sub-electrodes, and the second set of sub-electrodes comprises a single electrode.
